(19) United States
(12) Patent Application Publication
(10) Pub. No.: US 2011/0177147 A1
(43) Pub. Date: Jul. 21, 2011

(54) STABLE BIOCIDAL DELIVERY SYSTEMS

(75) Inventors: Matthew M. Hunter, Doylestown, PA (US); Jeffrey I. Melzer, Lansdale, PA (US); Claudia C. Pierce, Trenton, NJ (US); Linna Wang, Shanghai (CN); Wilson K. Whitekettle, Jamison, PA (US); Guixi Zhang, Shanghai (CN); Dorothy Reynolds, North Wales, PA (US)

(73) Assignee: GENERAL ELECTRIC COMPANY, Schenectady, NY (US)

(21) Appl. No.: 12/868,377

(22) Filed: Aug. 25, 2010

Related U.S. Application Data
(60) Provisional application No. 61/297,026, filed on Jan. 21, 2010.

(51) Int. Cl. A01N 25/28; A01N 43/80; A01P 1/00

(52) U.S. Cl. 424/408; 514/372

(57) ABSTRACT

An improved stabilized biocidal delivery system has been found which increases the efficiency and effectiveness of introducing antimicrobial compounds into complex bio-film matrices through the use of liposome vesicular carriers, thereby removing the bio-fouling in industrial water bearing systems, including piping, heat exchanges, condensers, filtration systems and fluid storage tanks. The improved stabilized biocide is comprised of a vesicle encapsulated biocide that is stabilized against chemical and heat degradation over longer periods of time than previously possible through the incorporation of a stabilizer compound.

### CROSS REFERENCE TO RELATED APPLICATION

The present application claims priority benefit under 35 USC §119 of U.S. Provisional Patent Application Ser. No. 61/297,026 filed Jan. 21, 2010.

### FIELD OF INVENTION

The field of the invention generally relates to biocidal delivery systems for providing products or compounds, such as chemicals, to industrial systems. The invention also relates to compositions for use in a targeted delivery of said compositions to bacterial bio-films in various environments.

### BACKGROUND OF THE INVENTION

Bacterial bio-films exist in natural, medical, and industrial environments. The bio-films offer a selective advantage to microorganisms to ensure the microorganisms' survival or to allow them a certain time to exist in a dormant state until suitable growth conditions arise. Unfortunately, this selective advantage poses serious threats to health, or to the efficiency and lifetime of industrial systems. The bio-films must be minimized or destroyed to improve the efficiency of industrial systems, or remove the potential health threats.

Many industrial or commercial operations rely on large quantities of water for various reasons, such as for cooling systems, or said systems may produce large quantities of wastewater, which result in the creation of bio-films that need to be treated. These industries include, but are not limited to, agriculture, petroleum, oil drilling, oil pipelines, oil storage, gas drilling, gas pipelines, gas storage, chemical, pharmaceutical, mining, metal plating, textile, papermaking, brewing, food and beverage processing, and semiconductor industries. In these operations, naturally occurring bio-films are continuously produced and often accumulate on numerous structural or equipment surfaces or on natural or biological surfaces. In industrial settings, the presence of these bio-films causes a decrease in the efficiency of industrial machinery, requires increased maintenance and presents potential health hazards. An example is the surfaces of water cooling towers which become increasingly coated with bio-film slimes produced by a wide variety of microorganisms which constrict water flow and reduce heat exchange capacity. Specifically, in flowing or stagnant water, bio-films can cause serious problems, including pipeline blockages and the corrosion of equipment by the growth of micro-organisms and microbes the thrive beneath the bio-film as well as the growth of potentially harmful pathogenic bacteria. Water cooling tower bio-films may form a harbor or reservoir that perpetuates growth of pathogenic microorganisms such as Legionella pneumophila.

Another example of industrial systems are those systems that are found in the food and beverage industries. Food preparation lines are routinely plagued by bio-film build-up both on the machinery and on the food product where bio-films often include potential pathogens. Industrial bio-films, such as those found in the food industry, are complex assemblages of insoluble polysaccharide-rich biopolymers, which are produced and elaborated by surface dwelling microorganisms. More particularly, bio-films or microbial slimes are composed of polysaccharides, proteins and lipopolysaccharides extruded from certain microbes that allow them to adhere to solid surfaces in contact with water environments and form persistent colonies of sessile bacteria that thrive within a protective film. The film may allow anaerobic species to grow, producing acidic or corrosive conditions. To control these problems, processes and antimicrobial products are needed to control the formation and growth of bio-films Control of bio-films involves the prevention of microbial attachment and/or the removal of existing bio-films from surfaces. While removal in many contexts is accomplished by short cleansing treatments with highly caustic or oxidizing agents, the most commonly used materials to control bio-films are biocides and dispersants.

In U.S. Pat. No. 5,411,666 to Hollis et al., a method of removing a bio-film or preventing buildup of a bio-film on a solid substrate is taught, that comprises a combination of at least two biologically produced enzymes, such as an acidic or alkaline protease and a glucoamylase or alpha amylase and at least one surfactant. U.S. Pat. No. 6,759,040 to Manyak et al. teaches a method for preparing bio-film degrading, multiple specificity, hydrolytic enzyme mixtures that are targeted to remove specific bio-films while U.S. Pat. No. 5,512,213 to Paterson et al. teaches a method for stabilizing an aqueous solution containing an isothiazolin compound against chemical decomposition through the incorporation of a stabilizing amount of a metal salt. The cation of said metal salt is an alkali metal while the anion is selected from the group consisting of acetate, citrate, phosphate and borate.

Finally, U.S. Pat. No. 6,267,897 to Robertson et al., relates to a method of inhibiting bio-film formation in commercial and industrial water systems by adding one or more plant oils to the system. However, although the biocides are effective in controlling dispersed microorganism suspensions, i.e., planktonic microbes, biocides do not work well against sessile microbes, the basis of bio-films. This is due to the fact that biocides have difficulty penetrating the polysaccharide/protein slime layers surrounding the microbial cells. Thicker bio-films see little penetration of biocides and poor biocide efficacy is the result. One known method of trying to better control bio-films has been the addition of dispersants and wetting agents to biocide compositions to enhance biocide efficacy. Bio-dispersants may operate to keep planktonic microbes sufficiently dispersed so that they do not agglomerate or achieve the local densities necessary to initiate the extracellular processes responsible for anchoring to a surface, or initiating film- or colony-forming mechanisms. As components in biocidal treatment formulations, these bio-dispersants have helped in opening channels in the bio-film to allow better permeability of the toxic agents and to better disperse the microbial aggregates and clumps that have been weakened and released from the surfaces. However, bio-dispersants have proven to be more effective in preventing initial bio-film formation than in removing existing bio-films. In many cases, the activity of bio-dispersants has been responsible for only 25 to 30% biomass removal from bio-fouled surfaces, even when used in conjunction with a biocidal agent.

Therefore, a clear need still exists for an efficient and effective means for delivering antimicrobial compounds that are better able to penetrate existing bio-films and bio-film matrices, and more effective in killing microorganisms contained within a bio-film matrix, thus killing and eliminating bio-film, as well as preventing future formation nor buildup of bio-film, in systems, such as industrial systems. Decreasing the fouling of microfiltration systems, and providing less frequent cleaning and/or replacement which would enhance the overall filtration process, are also needs which should be addressed.

### SUMMARY OF THE INVENTION

In one exemplary embodiment, a biocidal-delivery system has been found which increases the efficiency and effectiveness of introducing antimicrobial compounds into complex bio-film matrices, through the use of liposome carriers, which can be used in natural, medical and industrial applications. In industrial applications, the delivery system can minimize or eliminate fouling in industrial systems, including, but not limited to, aqueous systems, such as piping, heat exchangers, condensers, filtration systems and media, and fluid storage tanks.

According to one embodiment of the invention, liposomes containing an antimicrobial agent, such as a hydrophilic biocide, are added to a water system prone to bio-fouling and bio-film formation. The liposomes, being similar in composition to the outer surface of the microbial cell wall structure or to the material on which the microbes feed, are readily incorporated into the microbes present in the existing bio-film. Once the liposomes become entrained with the bio-film matrix, digestion, decomposition or degradation of the liposome proceeds, releasing the antimicrobial agent, or biocidal aqueous core reacts locally with the bio-film-encased microorganisms. Upon the death of the organisms, the polysaccharide/protein matrix cannot be replenished and decomposes and thereby results in reduced bio fouling of the water bearing system. Depending on the particular system involved, this bio-film removal or destruction therefore results in increased heat transfer (industrial heat exchanger), increased flux (filter or filtration membrane), less deposit of colloidal and particulate solids and dissolved organics on the surface of the microfiltration membrane, thereby reducing the frequency and duration of the membrane cleaning and ultimate replacement, or general reduction of corrosive surface conditions in pipelines, tanks, vessels or other industrial equipment.

An alternate embodiment of the invention provides for a delivery system of actives into a natural, medical or industrial system, which can be chosen from the group consisting of anti-corrosion treatments, pesticides for agriculture and commercial home uses, food additives and preservatives, chemical and biological detection, color and flavor enhancement, odor control and aquatic pest management.

More specifically, the present invention is an improvement of the delivery system described in the Published PCT Application WO 2009/020694 A1 wherein the liposome biocidal delivery system is formulated about a stabilized anti-microbial system comprised of a non-oxidizing biocide such as the group consisting of the isothiazolins. It has been found that isothiazolins undergo chemical decomposition in presence of high temperature, high pH, reducing agents, and aggressive nucleophiles. When liposome is added to isothiazolin solutions, the reducing property of lipids is detrimental to isothiazolin stability. The oxidizing properties and acidic salt solution (pH 1˜3) of the isothiazolin anti-microbial compounds also causes liposome degradation and eventually physical separation. At elevated temperature, these degradation and separation processes accelerate resulting in unsatisfactory product not suitable for commercial use. Individually, these biocides generally exhibit a greater than 50% degradation after one week at 50° C. for both materials. One aspect of the present invention then comprises the use of a stabilizing oxidizer composition such as sodium chlorate, and more particularly, a stabilized blend of a buffer selected from the group consisting of a citrate salt, a chlorate salt, an acetate salt and mixtures thereof. Even more preferred are stabilizer compositions comprised of a sodium citrate buffer, a sodium acetate buffer, a sodium chlorate buffer, a sodium citrate/sodium chlorate buffer mixture, and a sodium acetate/sodium chlorate buffer mixture.

The various features of novelty that characterize the invention are pointed out with particularity in the claims annexed to and forming a part of this disclosure. For a better understanding of the invention, its operating advantages and benefits obtained by its uses, reference is made to the accompanying drawings and descriptive matter. Changes to and substitutions of the various components of the invention can of course be made. The invention resides as well in sub-combinations and sub-systems of the elements described, and in methods of using them.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

A delivery system has been found which increases the efficiency and effectiveness of introducing antimicrobial compounds into complex bio-film matrices through the use of liposome carriers, which can be used in natural, medical and industrial applications. In industrial applications, the delivery system can minimize or eliminate fouling in industrial systems, including, but not limited to, aqueous systems, such as cooling towers, piping, heat exchangers, condensers, filtration systems and media, and fluid storage tanks.

According to one embodiment of the invention, liposomes containing a biocidal or antimicrobial agent or compound are added to an industrial system prone to bio-fouling and bio-film formation. The liposomes, being similar in composition to microbial membranes or cells, are readily incorporated into the existing bio-film. Once the antimicrobial compound-containing liposomes diffuse into, adsorb or otherwise become entrained with the bio-film matrix, the microorganisms existing within the bio-film matrix will ingest the liposome structure, resulting in the decomposition or disintegration of the liposome inside the intracellular matrix of the microorganism, thereby releasing the antimicrobial compound into the intracellular matrix of the microorganism, ultimately resulting in the death of the microorganism. That is lipid decomposition and biocide release can be programmed to occur by making the lipid matrix sensitive to pH, redox potential, Ca⁺² concentration, or other changes. Thereafter the biocidal component that may be concentrated in the aqueous core of the liposome or in the lipid membrane portion of the liposome, is released to react directly with the bio-film-encased microorganisms. Thus, rather than adding a biocide at high levels to the bulk water system, a small quantity of liposome-encased biocide is taken up by the bio-film or by free (planktonic) organisms, and degradation of the liposome releases the biocide locally in or at the target organisms or their film matrix niche. The biocide thus attains a high concentration locally to kill the target organisms, and upon the death of the organisms, the polysaccharide/protein matrix that forms the bio-film cannot be maintained or regenerated and decomposes, and thereby results in reduced fouling of the water bearing system, resulting in increased heat transfer, increased flux, less deposit of colloidal and particulate solids and dissolved organics on the surface of the micro-filtration membrane, thereby reducing the frequency and duration of the membrane cleaning and ultimate replacement or other benefits.

Liposomes, or lipid bodies, are systems in which lipids are added to an aqueous buffer to form vesicles, structures that enclose a volume. The liposomes may be comprised of lipids selected from the group consisting of phospholipids, lecithin, phosphatidyl choline, glycolipid, triglyceride, sterol, fatty acid, sphingolipid, or combinations thereof.

More specifically, liposomes are microscopic vesicles, most commonly composed of phospholipids and water. The liposomes may be made from phospholipids derived from various sources, including, but not limited to soybeans and eggs. When properly mixed, the phospholipids arrange themselves into a bi-layer or multi-layers, very similar to a cell membrane, surrounding an aqueous volume core. Liposomes can be produced to carry various compounds or chemicals within the aqueous core, or the desired compounds can be formulated in a suitable carrier to enter the lipid layer(s). Liposomes can be produced in various sizes and may be manufactured in submicron to multiple micron diameters. The liposomes may be manufactured by several known processes. Such processes include, but are not limited to, controlled evaporation, extrusion, injection, micro-fluid processors and rotor-stator mixers. Liposomes can be produced in diameters ranging from about 10 nanometers to greater than about 15 micrometers. When produced in sizes from about 100 nanometers to about 20 micrometer sizes the liposomes are very similar in size and composition to most microbial cells. The biocide or antimicrobial compound containing-liposomes should be produced in sizes that mimic bacterial cells, for example, from about 0.05 to about 15μ, or alternately, about 0.1 to 10.0μ. Details pertaining to liposome production processes may be gleaned, for example, in U.S. Pat. Nos. 5,807,572 and 7,491,409. Both of these patents are incorporated by reference herein.

In one embodiment, effective amounts of the biocide containing liposome is introduced into an industrial system which is prone to bio-fouling and bio-film formation, or can be introduced into systems that already exhibit signs of bio-fouling or bio-film formation. The effective amount will vary according to the antimicrobial compound or biocide, and the aqueous system to which it is added, but one embodiment provides from about 0.01 ppm to about 100 ppm, with an alternative of from about 0.05 to about 50 ppm, alternately from about 0.05 to about 5.0. The liposomes, being similar in composition to microbial membranes, or cell walls, are readily incorporated into the existing bio-film and become entrained within the bio-film matrix. The liposomes containing biocides have improved penetration of the bio-film matrix, due to similarity in composition and structure with the bio-film. Once the liposome is incorporated or entrained within the existing bio-film matrix, the liposome will begin to disintegrate. Upon the decomposition or programmed disintegration of the liposome, the biocidal compound contained within the aqueous core of the liposome is released to react directly with the bio-film encased microorganisms, resulting in their demise. Upon the death of the organisms, the polysaccharide/protein matrix will rapidly decompose, freeing the surface from contaminating microbes.

More specifically, one aspect of the present invention is directed to a liposomal-encapsulated biocidal delivery system wherein the non-oxidizing biocidal compound is stabilized by a citrate/chlorate buffer composition in which the mixture buffer provides a stability to the biocide active that is much greater than either of the buffers alone. A principal feature of one embodiment of the present invention is that the liposomes constitute extremely small hydrophobic bodies that may readily survive in and disperse in systems, such as for example, aqueous or natural systems, and yet will adsorb to or penetrate a bio-film and preferentially target or be targeted by the microbes that inhabit, constitute or sustain the bio-film. As such, the liposomes deliver a biocidal agent directly to the microbes or bio-film, resulting in effective locally biocidal level of activity, without requiring that the industrial system as a whole sustain a high dose. Thus, where conventional bio-film treatment may require dosing with a bulk biocidal chemical at a certain level, delivery via liposome may be dosed at levels an order of magnitude or more lower in the aqueous system, yet still achieve, or build up to a level that effectively controls or removes bio-film. This lower level of biocide concentration has positive effects on the environment due to the efficacy resulting from the delivery system. Additionally, depending upon the particular system that is being treated, an embodiment provides for flexibility in where the liposomes are actually delivered into the system. If there is one particular area in a system that is prone to bio-film creation, the delivery of the liposomes may be delivered to that particular portion or point of the system, such that the delivery of the biocidal delivery composition is to a targeted location, and not necessarily privy to or exposed to the entire system. As smaller doses of the liposome containing biocides are needed due to the efficacy of the biocides in this format, an entire system or process need not be flooded with or treated with biocides.

Indeed, while the terms “antimicrobial” or “biocide” or “biocidal” have been employed to describe the agent carried by the liposome, these agents need not be the highly bioactive materials normally understood by those terms, but may include a number of relatively harmless materials that become highly effective simply by virtue of their highly localized release. Thus, for example, surfactants or harmless ammonium or phosphonium halide salts, when released locally, may affect the normal action of extracellular colony-forming secretions, and are to be included as antimicrobial or biocidal agents for purposes of the invention, and the same mechanism may be employed to deliver other treatment chemicals to the targeted bio-film sites.

Aqueous systems that can be treated by this method include, but are not limited to, potable and non-potable water distribution systems, cooling towers, boiler systems, showers, aquaria, sprinklers, spas, cleaning baths, air washers, pasteurizers, air conditioners, fluid transporting pipelines, storage tanks, ion exchange resins, food and beverage processing lines, metalworking fluid baths, coal and mineral slurries, metal leaching fluids, wastewater treatment facilities, mollusk control, pulp and papermaking operations, acid mine drainage, or any application prone to bio-fouling by microbial species. Application such as oil drilling, oil storage tanks or oil pipelines, where bio-films form in stagnant or pooled aqueous sumps or lenses along the conduit system, may also be effectively treated.

Additional applications for liposome delivery of a treatment chemical comprise natural, medical and industrial systems, such as, but not limited to anti-corrosion treatments for equipment generally, delivery of hormone, vitamin or antioxidant treatments or antibiotic and gene therapies for medical or veterinary purposes, delivery of pesticides for agriculture and commercial home uses, effective formulations of food additives and preservatives, targeted delivery for chemical and biological detection systems, color and flavor enhancement, odor control, fungicides, rodenticides, insecticides, mildew control and aquatic pest management.

Anti-microbial liposomes are systems in which lipids are added to an aqueous anti-microbial compound solution to form vesicles, structures that enclose a portion of the anti-microbial solution. Liposomes maybe consist of lipids selected from the group consisting of phospholipids, lecithin, phosphatidyl choline, glycolipids, triglycerides, sterol, fatty acid, sphingolipid, or combinations thereof.

As briefly mentioned above, it is well documented that isothiazolins undergo chemical decomposition in presence of high temperature, high pH, reducing agents, and aggressive nucleophiles. When liposome is added to isothiazolin solutions, the reducing property of lipids is detrimental to isothiazolin stability. Moreover, the oxidizing properties and acidic salt solution (pH 1˜3) of the isothiazolin anti-microbial compounds also cause liposome degradation and eventually physical separation. At elevated temperature, these degradation and separation processes accelerate resulting in unsatisfactory product not suitable for commercial use.

One aspect of the present invention comprises the addition of a combination of a citrate salt, acetate salt, or chlorate salt buffer composition to the isothiazolin liposome composition to regulate pH and redox potential in the solution. The result is a stabilized micro-biocidal composition that is resistant to chemical decomposition and a homogenous liposome solution free of physical phase separation to a degree that is surprisingly and unexpectedly enhanced over the inclusion of either compound alone. Whereas theoretically any salt form may be used, the sodium salt form is preferable for any one of a number of reasons.

In order to prepare the isothiazolin anti-microbial liposome, lipids are added to an isothiazolin solution to form liposome vesicles, which encapsulate a portion of the isothiazolin compounds dissolved in solution. Individually, isothiazolins and liposomes are stable. Commercial isothiazolin products such as R&H Kathon® 886F is stabilized by magnesium nitrate. Commercial phospholipids and lecithin such as Cargill Lecigran® 6000G is stabilized by tocopherols. But when blended together, isothiazolin compounds and liposome are incompatible. Magnesium nitrate and tocopherols cannot provide sufficient stabilizing effect, resulting in chemical degradation of 3-isothiazolin and irreversible phase separation of the liposome lipids from the isothiazolin solution when the pH drops below 1.7 and temperature rises above 35° C. Additional stabilizers are needed to address these issues. In one embodiment, the present invention employs citrate buffers and chlorate salts as additional stabilizers to ensure product compatibility and extend shelf life. Suitable stabilizer buffer systems include sodium citrate, sodium chlorate, sodium acetate and mixtures thereof.

Various types of biocides, for example non-oxidizing biocides, can be incorporated into the liposome and are effective. Preferably, the non-oxidizing biocide useful in the practice of the present invention is an isothiazolin, most preferably, 3-isothiazolin. These isothiazolin-3-one liposome formulations are more effective at killing and removing bio-films when compared to the same isothiazolin-3-one compounds at the same active concentrations, which are introduced into systems, but not incorporated in liposomes, as the liposome containing biocides readily penetrate the microbial bio-films and are highly effective at destroying the bio-film matrix. This liposome delivery method may comprise 5-chloro-2-methyl-4-isothizolin-3-one and 2-methyl-4-isothiazolin-3-one, but any substituted isothiazolin-3-one based biocide can be made significantly more effective when delivered in a liposome biocidal delivery system or composition.

An example of an isothiazolin-3-one compound is

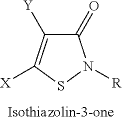

Where:
R=H, Cl, Br, I, CₙH₍ₙ₊₂₎
X=H, Cl, Br, I, CₙH₍ₙ₊₂₎
Y=H, Cl, Br, I, CₙH₍ₙ₊₂₎

In preparing the biocidal liposomes of the present invention comprising isothiazolin, the active isothiazolin compound is incorporated into the liposome in an amount of from about 1.0 wt % to about 12.0 wt % and preferably in an amount of from about 10.0 wt % to about 12.0 wt %. The amount of stabilizing buffer composition added to the liposome formulation is from about 0.02 wt % to about 10.0% wt % and, preferably, in an amount of from about 0.03 wt % to about 5.5 wt %. The liposome formulations are usually mixtures of particles of various sizes. Whereas the liposome particle sizes may be formulated up to 200 microns, preferably the liposome size useful in the practice of the present invention will range from about 100 nanometers to about 10 microns in diameter.

Liposomes of the present invention may be created as multi-layer bodies, in which one or more additional layers are provided to enhance the stability of the liposomes or to effectuate a programmed release of the underlying lipid body and contents. Thus, this technology may be used to encapsulate medicines for intra-corporal delivery, such that the additional layers may include a protective layer that is hydrolyzed or otherwise breaks down over time to provide a sustained release or longer lifetime of the underlying liposome. This additional layer may also include an encapsulating polymer that selectively breaks down when the multi-layer liposome encounters a low-pH environment, like the corrosive high acidity environment that may develop beneath a bio-film.

A layer may also be compounded to be vulnerable to sulfur-fixing bacteria, causing the liposome to specifically release its biocide in proximity to these corrosive organisms often present in a waste or pipeline system. Furthermore, several such layers may be employed to assure a sufficient lifetime of the liposome, preferably on the order of several days as well as an ability to target a specific niche or environment in the bio-film. This assures that the liposomes will effectively encounter the target organisms or bio-film colonies and deliver their biocides thereto. The lipid material itself may be treated to provide enhanced resistance to hydrolysis or decay, or the added layers may be formed of various hardened or cross-linkable oils or polymers.

An alternate embodiment of the invention provides for a biocidal delivery composition for delivering at least one antimicrobial composition into a bio-film present in an industrial system, wherein the bio-film comprises at least one microorganism species; b) the biocidal delivery composition comprises a liposome structure containing at least one lipid or phospholipid type component; and c) the liposome structure encapsulates at least one non-oxidizing antimicrobial composition in combination with a stabilizer composition.

A further embodiment provides for the targeted delivery of biocide actives into an industrial system, such as an industrial aqueous system, by introducing into said system an effective amount of said biocides in a critical area of said system. By targeting an area, and entry at a specific point in a process, the efficacy of the liposome system provides for a noteworthy impact on the environment as well as the cost of maintaining a system, as the entire system does not need to be flooded with biocides, only the specific area of interest.

The present invention will now be more specifically described and detailed in the following examples to better show one skilled in the art how to best carry out and practice the metes and bounds of the present invention. It is to be emphasized that they are for illustrative purposes only, and should not be construed as limiting the spirit and scope of the invention as recited in the claims that follow.

### Example

Three batches of liposomes (150 nanometers average diameter) were created that incorporated an isothiazolin biocide, Kathon™ (available from Rohm & Haas, Philadelphia, Pa.) as the active ingredient. The liposomes were then placed in microtiter plates that had microbial bio-films coating them. The microbe inhibiting efficacy of the isothiazolin liposomes was then compared with non-liposomal isothiazolin biocide when used at the same isothiazolin concentrations. The liposomes containing isothiazolin penetrated the bio-film and inhibited the bio-film organisms much more effectively than the non-liposomal isothiazolin solution. The biocide-containing liposomes were comprised of the following components in their respective percent ranges.

| Component | Percentage (% by wt) |
|---|---|
| a) KATHON ® 886F (14.0% isothiazolin) | 78.67 |
| b) DEIONIZED WATER | 0.67 |
| c) LECIGRAN ® 6000G | 10.0 |
| d) SODIUM CHLORATE (50% sol.) | 8.0 |
| e) SODIUM CITRATE DIHYDRATE | 2.33 |
| f) CITRIC ACID MONOHYDRATE | 0.33 |

The degradation of the 3-isothiazolin liposomes can be qualitatively observed by the formation of an insoluble precipitate. Quantitatively, gas chromatography (GC) and high pressure liquid chromatography (HPLC) analysis were used to determine actives concentrations for samples stored under accelerated storage conditions (50° C.). The stability of isothiazolin liposomes known in the art are as follows.

Various isothiazolin formulations with stabilizers were tested at 38° C. and 50° C. As can be seen from Table 1 below, the citrate buffer and chlorate salt stabilizer combination extended shelf life from 29 days to 85 days during 38° C./100° F. storage, while either the citrate buffer or chlorate salt alone only extends shelf life to 49 and 42 days, respectively. Thirteen (13) stabilized anti-microbial liposomal compositions were prepared in the following component ratios as set forth in Table 1. The isothiazolin-encapsulated liposomes with the different buffer stabilizer compounds incorporated therein were compared for stability over time at the four (4) different temperatures and the days to irreversible separation are set forth below:

TABLE 1

| | | % Kathon | | % Sodium | | Buffer | | |
|---|---|---|---|---|---|---|---|---|
| Sample | Formulation | active | % Lecithin | Chlorate | % Buffer | Strength (M) | 38□C./100□F. | 50□C./120° F. |
| ND 1000 | | 12 | 10 | — | — | — | 29 | 7 |
| A | Sodium Acetate Buffer | 12 | 10 | — | 0.30 | 0.04 | 42 | 7 |
| B | Sodium Acetate Buffer | 12 | 8 | — | 0.45 | 0.06 | 42 | 7 |
| C | Sodium Acetate Buffer | 10 | 8 | — | 1.55 | 0.21 | 23 | 7 |
| D | Sodium Citrate Buffer | 12 | 10 | — | 1.09 | 0.04 | 42 | 7 |
| E | Sodium Citrate Buffer | 12 | 8 | — | 1.65 | 0.06 | 37 | 6 |
| F | Sodium Citrate Buffer | 10 | 8 | — | 5.66 | 0.21 | 42 | 6 |
| I | Sodium Chlorate | 12 | 10 | 4 | 0.00 | 0.00 | 42 | 4 |
| J | Sodium Chlorate | 12 | 8 | 8 | 0.00 | 0.00 | 37 | 4 |
| M | Acetate Buffer | 12 | 10 | — | 0.30 | 0.08 | 42 | x |
| O | Citrate Buffer | 12 | 10 | — | 1.09 | 0.08 | 49 | x |
| Q | Sodium Chlorate/ | 11 | 10 | 4 | 0.30 | 0.08 | 51 | 11 |
| | Sodium Acetate Buffer | | | | | | | |
| R | Sodium Chlorate/ | 11 | 10 | 4 | 2.67 | 0.08 | 85 | 17 |
| | Sodium Citrate Buffer | | | | | | | |

It is evident from the table that the sodium citrate/sodium chlorate buffer composition provided unexpectedly high levels of stability for the liposome-biocide composition than either buffer added alone. Stability of the anti-microbial liposomal compounds was the measured as a function of pH over time. Whereas the liposomes containing the isothiazolin/sodium acetate buffer and the isothiazolin/sodium citrate buffers alone showed good biocidal stability at 38° C./100° F. for forty-two (42) and forty-nine (49) days respectively, liposomes containing the isothiazolin biocide with combinations of the sodium acetate/sodium chlorate and sodium citrate/sodium chlorate buffers exhibited surprisingly superior biocidal stability at the same elevated temperatures for fifty-one (51) and eighty-five (85) days, respectively.

In addition to the foregoing, the biocide may be any type of biocide that is suitable for killing or destroying the desired microbial organism. In one embodiment, the biocide may be a non-oxidizing or oxidizing compound, or combinations thereof. In another embodiment, the biocide includes, but is not limited to, guanidine or biguanidine salts, quaternary ammonium salts, phosphonium salts, 2-bromo-2-nitropropane-1,3-diol, 5-chloro-2-methyl-4-isothiazolin-3-one/2-methyl-4-isothiazolin-3-one, n-alkyl-dimethylbenzylammonium chloride, 2,2,dibromo-3-nitrilopropionamidemethylene-bis(thiocyanate), dodecylguanidine hydrochloride, glutaraldehyde, 2-(tert-butylamino)-4-chloro-6-(ethylamino)-s-triazine, beta-bromonitrostyrene, tributyltinoxide, n-tributyltetradecyl phosphonium chloride, tetrahydroxymethyl phosphonium chloride, 4,5,-dichloro-1,2,-dithiol-3-one, sodium dimethyldithiocarbamate, disodium ethylenebisdithiocarbamate, Bis(trichloromethyl) sulfone, 3,5-dimethyl-tetrahydro-2H-1,3,5,-thiadiazine-2-thione, 1,2,-benzisothiazolin-3-one, decylthioethylamine hydrochloride, copper sulfate, silver nitrate, bromochlorodimethylhydantoin, sodium bromide, dichlorodimethylhydantoin, sodium hypochlorite, hydrogen peroxide, chlorine dioxide, sodium chlorite, bromine chloride, peracetic acid and precursors, sodium trichloroisocyanurate, sodium trichloroisocyanurate, dibromo, dicyano butane and combinations thereof.

In one embodiment, the biocide may be guanidine or biguanidine salts, quaternary ammonium salts and phosphonium salts. Examples of guanidine or biguanidine salts are of the general formulas:

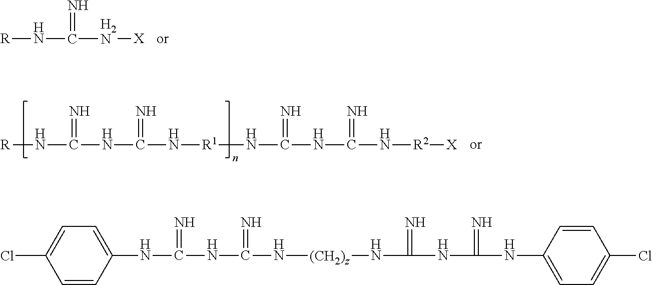

wherein R, R¹, R² are independently H, C₁-C₂₀ substituted or non-substituted alkyl (linear or branched) or aryl, X is an organic or inorganic acid, n is 0-20 and z is 1-12.

Examples of the general formula of acceptable phosphonium salts comprises (R₁)₃P⁺R².X⁻ wherein R¹ is an alkyl group of from 1 to 8 carbon atoms, R₂ is an n-alkyl group giving 8 to 20 carbon atoms, and X is an anion consisting of a halide, sulfate, nitrate, nitrite, and combinations thereof.

An alternative formula provides that R₁ is an alkyl group having from 1-8 carbons, R₂ is an n-alkyl group having 6-20 carbon groups, and X⁻ is an anion such as halides, sulfates, nitrates, nitrites and mixtures thereof. Preferably, X⁻ is chloride, bromide, iodide, SO₄⁼, and NO₃⁻, NO₂⁻ or mixtures thereof.

Another embodiment provides R₁ and R₂ are hydroxyalkyl groups having from 1-4 carbons and X⁻ is an anion such as halides, sulfates, nitrates, nitrites and mixtures thereof. Preferably, X⁻ is chloride, bromide, iodide, SO₄⁼, and NO₃⁻, NO₂⁻ or mixtures thereof.

Quaternary ammonium salts are another example of a biocide or agent that may be encapsulated or manufactured into a liposome core, and are of the general formula

R₁R₂R₃N⁺—CH₂-benzyl ring X.

wherein R₁ is an n-alkyl group of chain length C₈-C₁₈; R₂ and R₃ are CH₃ or n-alkyl group of chain length C₂-C₈ and X⁻ is an anion such as halides, sulfates, nitrates, nitrites and mixtures thereof.

The non-biocidal agents may be any type of environmentally friendly compound or composition that removes or inactivates the protozoa to keep it from spreading, such as by interfering with its life or reproductive cycle. In one embodiment, the non-biocidal agent may be used as an adjuvant with a biocide. For example, non-biocidal agents include, but are not limited to, biodispersants, ethylene oxide/propylene oxide copolymers, trichlorohexanoic acid, polysiloxanes, carbosilanes, polyethyleneimine, bacteria, microorganisms, plasmids, phagocytes, macrophages, toxin-producing microorganisms, amino acids, proteins, peptides, DNA, RNA, base pairs, antisense RNA pharmaceuticals, antibiotics, chelators, natural extracts, organic/inorganic redox agents, organic and inorganic dye sensitizers, apoptosis signaling reagent, microorganism- and plant-derived extracts and by-products, metabolic components, preservatives, toxic phytochemicals, microbial toxins, catalysts that generate free radicals or active oxygen species, L-cystin and enzymes or combinations thereof.

The biocide and stabilizer may be incorporated into the vesicle in any amount sufficient for controlling the microbial organism and will depend on the specific biocide and stabilizer chosen. In one embodiment, the biocide or non-biocidal agent is incorporated into a liposome vesicle in an amount of from about 1.0 wt %-12 wt %, and the stabilizer is added to the vesicle in an amount of about 0.02-10.0 wt %.

In one embodiment, the vesicles are added to the aqueous system in effective amounts, such that the amount of the biocide is introduced into the aqueous system from about 0.05 to about 500 micrograms per milliliter. In another embodiment, the vesicles are added to the aqueous system such that the amount of the biocide agent is introduced into the aqueous system from about 0.1 to about 100 micrograms per milliliter. In another embodiment, the vesicle is added to the aqueous system in an amount of from about 0.01 ppm by volume to about 100 ppm by volume. In another embodiment, the vesicle is added to the aqueous system in an amount of from about 0.01 ppm by volume to about 50 ppm by volume. In another embodiment, the vesicle is added in an amount of from about 0.01 ppm by volume to about 20 ppm by volume. In another embodiment, the vesicle is added to the aqueous system in an amount of from about 0.05 ppm by volume to about 5.0 ppm by volume.

In addition to the exemplary stabilizing agents noted above, additional stabilizing agents that may be mentioned include:
a) KIO₃, HIO₃, periodic, periodate salts
b) metal nitrates—Na, K, Ca, Mg
c) orthoesters—trimethyl orthoformate, triethyl orthoformate, triethyl orthoacetate, trimethyl orthovalerate, trimethyl orthobenzoate
d) formaldehyde releases
e) phenoxyalkanols—phenoxyethanol, phenoxy isopropanol
f) nitrogen based heterocyclic thiols—2 mercapto pyridine, MTZ, 2-thiohydantoin, L-cystin
g) EDTA
h) rheological modification agents such as thickeners
i) stearic hindrance agents (long chain repulsive)
j) yield value modification (carbon as suspending agent)

In accordance with one embodiment of the invention, a stabilized biocidal delivery composition is provided for delivering at least one anti-microbial composition into a bio-film present in an industrial system. The biofilm comprises at least one micro-organism species therein, and the biocidal delivery composition comprises a liposome vesicular structure contain at least one lipid or phospho-lipid component. Further, the liposome structure encapsulates at least one antimicrobial composition in combination with at least one stabilizer agent. In another aspect of the invention, the lipid is a member selected from the group consisting of phospholipids, lecithin, phosphatidyl choline, glycolipid, triglyceride, sterol, fatty acid, sphingolipid, or combinations thereof. In certain aspects of the invention, the phospholipid may be derived from soybeans or eggs. Further, the lecithin may be a mixture of lipids.

In accordance with an exemplary embodiment of the invention, the antimicrobial composition comprises at least one biocide, such as a nonoxidizing biocide. The biocide may, for example, be an isothiazolin compound. More specifically, the isothiazolin biocide may comprise at least one member selected from the group consisting of 5-chloro-2-methyl-4-isothizolin-3-one, 2-methyl-4-isothiazolin-3-one, or any combinations thereof.

In another exemplary embodiment, the stabilizer agent or compound is a buffer comprised of a mixture of two or more compounds selected from the group consisting of a citrate salt, a chorate salt buffer, and an acetate salt. The stabilizer compound buffer may be comprised of a mixture of two or more compounds selected from the group consisting of the metal salt of a citrate/chorate buffer, a metal salt of an acetate/chlorate buffer, and a citrate/acetate buffer. The buffer stabilizer may be selected from the group consisting of a sodium citrate buffer, a sodium acetate buffer, a sodium citrate/sodium chlorate buffer mixture, and a sodium acetate/sodium chlorate buffer mixture. The buffer stabilizer may be incorporated with the isothiazolin biocide in an amount from about 0.2% to about 10% of the total biocide liposome composition, and more preferably, the isothiazolin biocide may be incorporated in an amount of about 1.0 wt % to about 12.0 wt % of the total biocide liposome composition. Even more specifically, the isothiazolin biocide may be incorporated in an amount of about 10.0 wt % to about 12.0 wt % of the total biocide liposome composition. The liposome structure may be up to about 200 microns in diameter and preferably, is between about 100 nanometers to about 10 microns in diameter. The industrial system may be an aqueous system. The industrial system can be chosen from the group consisting of water distribution systems, cooling towers, boiler systems, showers, aquaria, sprinklers, spas, cleaning bath systems, air washers, pasteurizers, air conditioners, fluid transporting pipelines, storage tanks, ion exchange resins, food and beverage processing lines, paint spray booths, metalworking fluid baths, coal and mineral slurries, metal leaching fluids, wastewater treatment facilities, pulping and papermaking suspensions, mollusk control, acid mine drainage, oil drilling pipes, oil pipelines, oil storage tanks, gas drilling pipes, gas pipelines, or any industrial application prone to microbial induced bio-film formation or microbial induced corrosion.

In another aspect of the invention, methods are disclosed for delivering an antimicrobial composition into a biofilm in an industrial system comprising the steps of: a) forming a liposome vesicular structure which encapsulates at least one isothiazolin antimicrobial composition in combination with a buffer stabilizer comprised of a mixture of two or more compounds selected from the group consisting of a citrate salt, a chlorate salt, and an acetate salt, and b) introducing an effective amount of the liposomes from a) above to the industrial system that is prone to biofouling or biofilm formation. The liposome structure may be introduced at about 0.01 ppm to about 100 ppm. Further, the liposome structures may be introduced in the industrial system at certain targeted locations thereof. The liposome structure may comprise a biocide such as an isothiazolin biocide, and the isothiazolin biocide may be selected from the group consisting of 5-chloro-2-methyl-4-isothizolin-3-one, 2-methyl-4-isothiazolin-3-one, and mixtures thereof.

The buffer stabilizer may be selected from the group consisting of a sodium citrate buffer, a sodium acetate buffer, a sodium citrate/sodium chlorate buffer mixture, and a sodium acetate/sodium chlorate buffer mixture. Further, the buffer stabilizer is incorporated in an amount of 0.2 wt % to about 10 wt % of the total biocide liposome composition. In another embodiment, the isothiazolin biocide is incorporated in an amount of 1.0 wt % to about 12.0 wt % of the total biocide liposome composition.

1. A stabilized biocidal delivery composition for delivering at least one anti-microbial composition into a bio-film present in an industrial system, wherein
a) the bio-film comprises at least one micro-organism species;
b) the biocidal delivery composition comprises a vesicular structure; and
c) the vesicular structure encapsulates at least one antimicrobial composition in combination with at least one stabilizer composition.

2. The biocidal delivery composition of claim 1 wherein said vesicular structure is composed of a liposome structure containing at least one lipid or phospholipid component.

3. The biocidal delivery composition of claim 2 wherein the lipid is one member selected from the group consisting of phospholipids, lecithin, phosphatidyl choline, glycolipid, triglyceride, sterol, fatty acid, sphingolipid, or combinations thereof.

4. The biocidal delivery composition of claim 3 wherein the lipid is a phospholipid.

5. The biocidal delivery composition of claim 4 wherein the phospholipid is derived from soybeans or eggs.

6. The biocidal delivery composition of claim 3 wherein the lecithin is a mixture of lipids.

7. The biocidal delivery composition of claim 3 wherein the antimicrobial composition comprises at least one biocide.

8. The biocidal delivery composition of claim 7 wherein the antimicrobial composition comprises a non-oxidizing biocide.

9. The biocidal delivery composition of claim 8 wherein the biocide is an isothiazolin compound.

10. The biocidal delivery composition of claim 9 wherein the isothiazolin biocide comprises at least one member chosen from the group consisting of 5-chloro-2-methyl-4-isothizolin-3-one, 2-methyl-4-isothiazolin-3-one, or any combinations thereof.

11. The biocidal delivery composition of claim 10 wherein the stabilizer compound is a buffer comprised of a mixture of two or more compounds selected from the group consisting of a citrate salt, a chlorate salt buffer, and an acetate salt.

12. The biocidal delivery composition of claim 11 wherein the stabilizer compound is a buffer comprised of a mixture of two or more compounds selected from the group consisting of the metal salt of a citrate/chlorate buffer, a metal salt of acetate/chlorate buffer, and a citrate/acetate buffer.

13. The biocidal delivery system of claim 11 wherein said buffer stabilizer is selected from the group consisting of a sodium citrate buffer, a sodium acetate buffer, a sodium citrate/sodium chlorate buffer mixture, and a sodium acetate/sodium chlorate buffer mixture.

14. The biocidal delivery system of claim 13 wherein said buffer stabilizer is incorporated with said isothiazolin biocide in an amount of from about 0.2% to about 10% of the total biocide liposome composition.

15. The biocidal delivery system of claim 14 wherein said isothiazolin biocide is incorporated in an amount of from about 1.0 wt % to about 12.0 wt % of the total biocide liposome composition.

16. The biocidal delivery system of claim 15 wherein said isothiazolin biocide is incorporated in an amount of from about 10.0 wt % to about 12.0 wt % of the total biocide liposome composition.

17. The biocidal delivery composition of claim 16 wherein the liposome structure is up to about 200 microns in diameter.

18. The biocidal delivery composition of claim 17 wherein the liposome structure is between about 100 nanometers to about 10 microns in diameter.

19. The biocidal delivery composition of claim 18 wherein the industrial system is an aqueous system.

20. The biocidal delivery composition of claim 19 wherein the industrial system is chosen from the group consisting of water distribution systems, cooling towers, boiler systems, showers, aquaria, sprinklers, spas, cleaning bath systems, air washers, pasteurizers, air conditioners, fluid transporting pipelines, storage tanks, ion exchange resins, food and beverage processing lines, paint spray booths, metalworking fluid baths, coal and mineral slurries, metal leaching fluids, wastewater treatment facilities, pulping and papermaking suspensions, mollusk control, acid mine drainage, oil drilling pipes, oil pipelines, oil storage tanks, gas drilling pipes, gas pipelines, or any industrial application prone to microbial induced bio-film formation or microbial induced corrosion.

21. A method for delivering an antimicrobial composition into a bio-film in an industrial system comprising the steps of: a) forming a liposome structure which encapsulates at least one isothiazolin antimicrobial composition in combination with a buffer stabilizer comprised of a mixture of two or more compounds selected from the group consisting of a citrate salt, a chlorate salt, and an acetate salt; and b) introducing an effective amount of the liposomes of a) above to an industrial system that is prone to bio-fouling or bio-film formation.

22. The method of claim 21 wherein the liposome structures are introduced at from about 0.01 ppm to about 100 ppm.

23. The method of claim 22 wherein the liposome structures are introduced in the industrial system at a targeted location.

24. The method of claim 23 wherein the liposome structure comprises a biocide.

25. The method of claim 24 wherein the biocide is an isothiazolin biocide.

26. The method of claim 25 wherein the isothiazolin biocide is selected from the group consisting of 5-chloro-2-methyl-4-isothizolin-3-one, 2-methyl-4-isothiazolin-3-one, and mixtures thereof.

27. The method of claim 26 wherein said buffer stabilizer is selected from the group consisting of a sodium citrate buffer, a sodium acetate buffer, a sodium citrate/sodium chlorate buffer mixture, and a sodium acetate/sodium chlorate buffer mixture.

28. The method of claim 27 wherein said buffer stabilizer is incorporated in an amount of from about 0.2 wt % to about 10 wt % of the total biocide liposome composition.

29. The biocidal delivery system of claim 14 wherein said isothiazolin biocide is incorporated in an amount of from about 1.0 wt % to about 12.0 wt % of the total biocide liposome composition.
